(19) United States
(12) Patent Application Publication
(10) Pub. No.: US 2022/0269533 A1
(43) Pub. Date: Aug. 25, 2022

(54) STORAGE MEDIUM, JOB PREDICTION SYSTEM, AND JOB PREDICTION METHOD

(71) Applicant: FUJITSU LIMITED, Kawasaki-shi (JP)

(72) Inventor: Shigeto SUZUKI, Kawasaki (JP)

(73) Assignee: FUJITSU LIMITED, Kawasaki-shi (JP)

(21) Appl. No.: 17/742,435

(22) Filed: May 12, 2022

Related U.S. Application Data
(63) Continuation of application No. PCT/JP2019/049183, filed on Dec. 16, 2019.

(51) Int. Cl. G06F 9/48; G06N 20/00

(52) U.S. Cl. CPC G06F 9/4881; G06N 20/00

(57) ABSTRACT

A storage medium storing a job prediction program that causes a computer to execute a process includes extracting a first job that has a similar topic distribution to a prediction target job from a plurality of past jobs based on a first topic model trained with information regarding a plurality of jobs; extracting a second job that has a similar topic distribution to the prediction target job from the plurality of past jobs based on a second topic model trained with information regarding a job of which the data input/output amount is equal to or more than a predetermined value, the job being a part of the plurality of jobs of which information is used to train the first topic model; and outputting the data input/output amount of the first job or the second job.

### CROSS-REFERENCE TO RELATED APPLICATION

This application is a continuation application of International Application PCT/JP2019/049183 filed on Dec. 16, 2019 and designated the U.S., the entire contents of which are incorporated herein by reference.

### FIELD

The disclosed technology relates to a storage medium, a job prediction system, and a job prediction method.

### BACKGROUND

For example, a file system in a large high performance computer (HPC) system or the like often has a two-layer structure. Specifically, that is a two-layer structure including a global file system that is provided away from a calculation node and has a large-capacity storage in which all data is aggregated and a local file system that is provided in the immediate vicinity of the calculation node and has a storage that stores only data used for calculation. In this case, when calculation processing is executed by the calculation node, first, necessary data is moved from the global file system to the local file system. Then, the calculation processing is executed while the calculation node reads and writes data from and to the storage of the local file system, and the calculation node moves the calculation result from the local file system to the global file system.

Here, an input/output instruction of data from each job to the local file system is aggregated in a small number (for example, one or two) management servers, and an execution instruction is issued to a processing server that actually executes processing. In a case where the input/output instructions are concentrated on this management server, it is not possible for the management server to process the input/output instructions, the input/output instruction of each job is in a waiting state, and a job processing speed, in other words, an HPC performance deteriorates. Therefore, it is considered to prevent decrease in the job processing speed caused by the input/output instructions by predicting an amount of input/output instructions issued by each job and adjusting a job execution order so that the input/output instructions are not concentrated on the management server before the execution of the job.

For example, a system is proposed that effectively schedules reading and writing operations between a plurality of solid storage devices. This system includes a client computer and a data storage array coupled to each other via a network. Furthermore, the data storage array uses a solid state drive and a flash memory cell to store data. A storage controller in the data storage array includes an I/O scheduler. Then, this system uses characteristics of a corresponding storage device and schedules I/O requests to the storage device in order to maintain a relatively-stable response time at the time of prediction. The storage controller is configured to schedule a proactive action for reducing the number of times of unscheduled behaviors in the storage device so as to reduce a possibility of the unscheduled behavior of the storage device.

Patent Document 1: Japanese Laid-open Patent Publication No. 2016-131037

### SUMMARY

According to an aspect of the embodiments, a non-transitory computer-readable storage medium storing a job prediction program that causes at least one computer to execute a process, the process includes extracting a first job that has a topic distribution of which a similarity to a topic distribution of a prediction target job is equal to or more than a threshold from among a plurality of past jobs that has an information indicating a data input/output amount at the time of job execution based on a first topic model trained with information regarding a plurality of jobs; extracting a second job that has a topic distribution of which a similarity to the topic distribution of the prediction target job is equal to or more than a threshold from among the plurality of past jobs based on a second topic model trained with information regarding a job of which the data input/output amount is equal to or more than a predetermined value, the job being a part of the plurality of jobs of which information is used to train the first topic model; and outputting the data input/output amount of at least one job selected from the first job and the second job that has the topic distribution of which the similarity is up to a predetermined order from a top as a prediction value of the data input/output amount of the prediction target job.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of a job control system;

FIG. 2 is a diagram illustrating an example of a job information table included in a job DB;

FIG. 3 is a diagram illustrating an example of an IO data table included in the job DB;

FIG. 4 is a diagram for explaining prediction of IO data using a general topic model;

FIG. 5 is a diagram for explaining prediction of IO data according to the present embodiment;

FIG. 6 is a diagram illustrating an example of an overall topic model or a large IO topic model;

FIG. 7 is a diagram illustrating an example of a topic distribution based on the overall topic model or a topic distribution based on the large IO topic model;

FIG. 8 is a functional block diagram of a prediction unit;

FIG. 9 is a diagram for explaining a problem of comparing COS similarities between topic distributions using a plurality of topic models;

FIG. 10 is a diagram illustrating an example of an extraction job DB;

FIG. 11 is a diagram for explaining an approximation degree of IO data for topic model update processing;

FIG. 12 is a block diagram illustrating a schematic configuration of a computer that functions as a job prediction system;

FIG. 13 is a flowchart illustrating an example of training processing;

FIG. 14 is a flowchart illustrating an example of prediction processing; and

FIG. 15 is a flowchart illustrating an example of update processing.

### DESCRIPTION OF EMBODIMENTS

In order to avoid concentration of input/output instructions on a management server, it is necessary to appropriately predict an input/output amount of each job.

As one aspect, an object of the disclosed technology is to improve prediction accuracy of an input/output amount of a job.

As one aspect, an effect that prediction accuracy of a prediction model can be improved is obtained.

Hereinafter, an example of an embodiment according to the disclosed technology will be described with reference to the drawings.

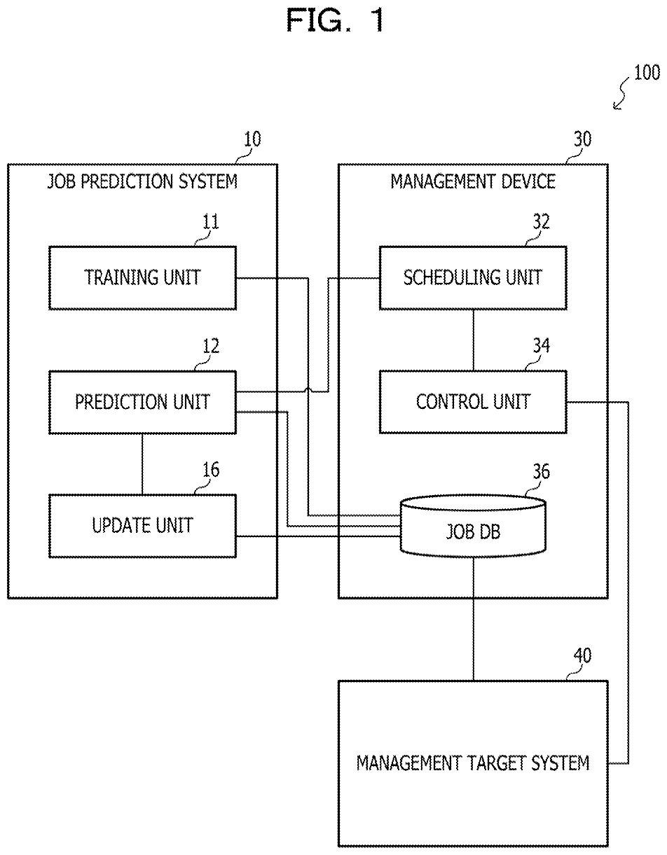

As illustrated in FIG. 1, a job control system 100 includes a management target system 40 such as a high performance computer (HPC), a management device 30 that manages the management target system 40, and a job prediction system 10. The job prediction system 10 predicts time-series data (hereinafter, referred to as “IO data”) of an input/output amount at each time when the management target system 40 executes a job, that is, an amount of an input/output instruction (input/output instruction, hereinafter, referred to as “IO instruction”).

The management device 30 functionally includes a scheduling unit 32 and a control unit 34 as illustrated in FIG. 1. Furthermore, a job database (DB) 36 is stored in a predetermined storage region of the management device 30.

The scheduling unit 32 determines a schedule regarding execution of each job. At this time, the scheduling unit 32 determines the schedule of each job so that the IO instructions do not concentrate on a management server in the management target system 40 on the basis of a prediction result of IO data of each job predicted by a prediction unit 12 of the job prediction system 10 to be described later.

The control unit 34 controls the execution of the job by outputting an instruction to the management target system 40 so that the job is executed according to the schedule determined by the scheduling unit 32.

The job DB 36 stores a job information table and an IO data table.

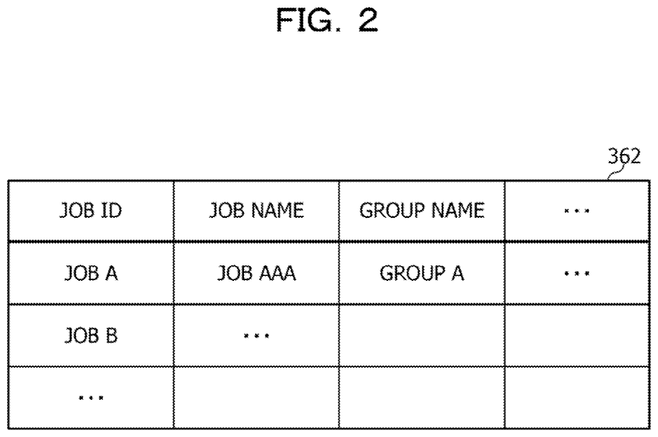

In the job information table, information regarding each job input to the management target system 40 (hereinafter, referred to as “job information”) is stored. In FIG. 2, an example of a job information table 362 is illustrated. In the example in FIG. 2, each row (each record) corresponds job information regarding one job. Each piece of the job information includes information such as a “job ID” that is job identification information, a “job name”, or a “group name” that is name of a group to which the job belongs. In addition, the job information may include information such as a user name, a specified time when the job is executed, or the number of nodes for executing the job.

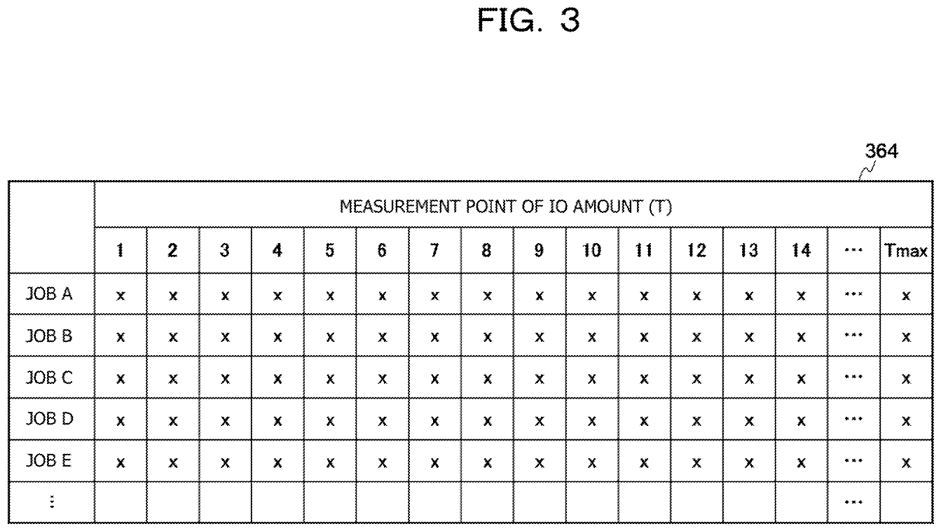

In the IO data table, an IO amount for each job measured at each measurement point by the management target system 40, that is, IO data is stored. In FIG. 3, an example of an IO data table 364 is illustrated. The measurement points have a predetermined time intervals (for example, five-minute intervals), and a measurement point 1, a measurement point 2, . . . are set as time elapses from job execution start. In the following, a measurement point i is referred to as “Ti”. Furthermore, in the example in FIG. 3, a measurement point corresponding to a maximum execution time of a job set by a user is set as “Tmax”. For example, in a case where the maximum execution time of the job is 24 hours and the time interval of the measurement points is provided for each five minutes, Tmax=T288.

As described above, the job prediction system 10 predicts the IO data of each job executed by the management target system 40. In the present embodiment, a past job similar to a prediction target job of which IO data is predicted is extracted using a topic model, and IO data of the extracted job is assumed as a prediction value of the IO data of the prediction target job. The topic model is a model that assumes that a document be stochastically generated from a plurality of potential topics or a model that assumes that each word in the document appears according to a probability distribution of a certain topic.

Here, a method for extracting a job similar to a prediction target job using a general topic model will be described.

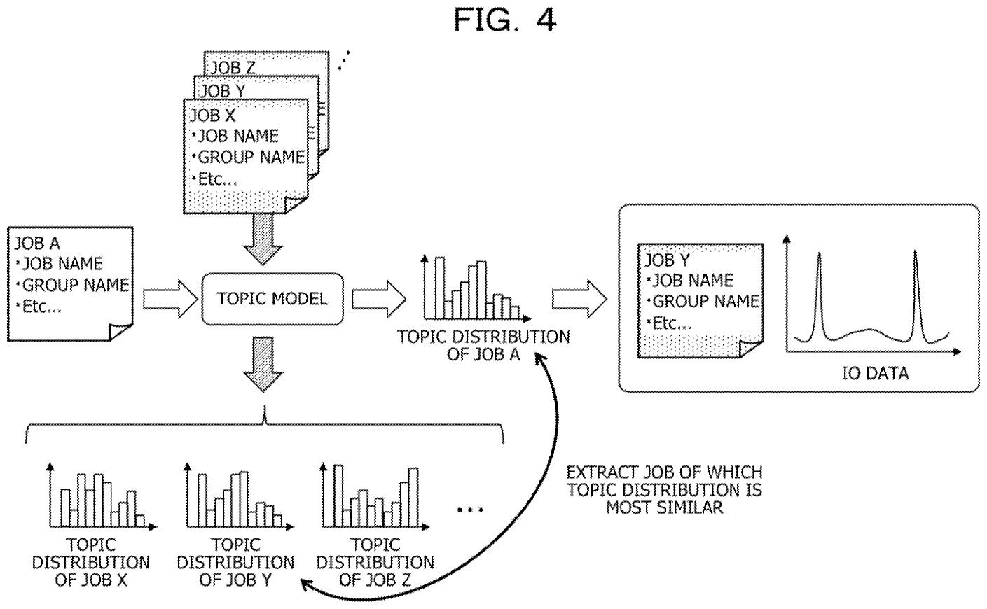

Job information of each of a plurality of past jobs of which IO data is known is trained, and a topic model is generated. Then, as illustrated in FIG. 4, by using job information of a prediction target job A and the topic model that has been trained in advance, a topic distribution of the job A is calculated. The topic distribution is a probability that each topic defined by a topic model appears in a target document (job information in the present embodiment). Similarly, a topic distribution of each of jobs X, Y, Z, . . . is calculated using job information of past jobs X, Y, Z, . . . and the topic model.

Then, a job having a topic distribution most similar to the topic distribution of the prediction target job A (job Y in example in FIG. 4) is extracted. Therefore, IO data of the extracted job Y is output as a prediction value of IO data of the job A.

Here, for example, assuming that power consumption at the time of job execution is predicted, it is considered to extract a job similar to a prediction target job using a topic model as described above. In this case, any job consumes power equal to or more than a certain amount. Therefore, even if the job information of the past jobs is collectively trained, it is possible to generate a topic model of which extraction accuracy of similar jobs is guaranteed for any job to some extent.

On the other hand, in a case where it is assumed that the IO data be predicted, some small number of jobs may issue a large number of IO instructions. Therefore, with the topic model that has collectively trained the job information of the past jobs, there is a case where extraction accuracy of the job (hereinafter, referred to as “large IO job”) that issues a large number of IO instructions as described above is not guaranteed. In other words, although the number of past jobs similar to the prediction target job is small, a search target is wide. Therefore, there is a possibility that a wrong job is extracted even though there is a more similar past job.

For example, regarding jobs that have been actually operated in a certain HPC system, a result is obtained that an IO amount of about 90% of jobs is less than 400 times/10 minutes and an IO amount of about 10% of jobs is equal to or more than 400 times/10 minutes. In this way, although a ratio of the large IO job to the entire job is small, the IO amount is large. Therefore, in a case where a purpose is to avoid concentration of IO instructions on the management server, it is desirable to accurately predict the IO data of such a large IO job.

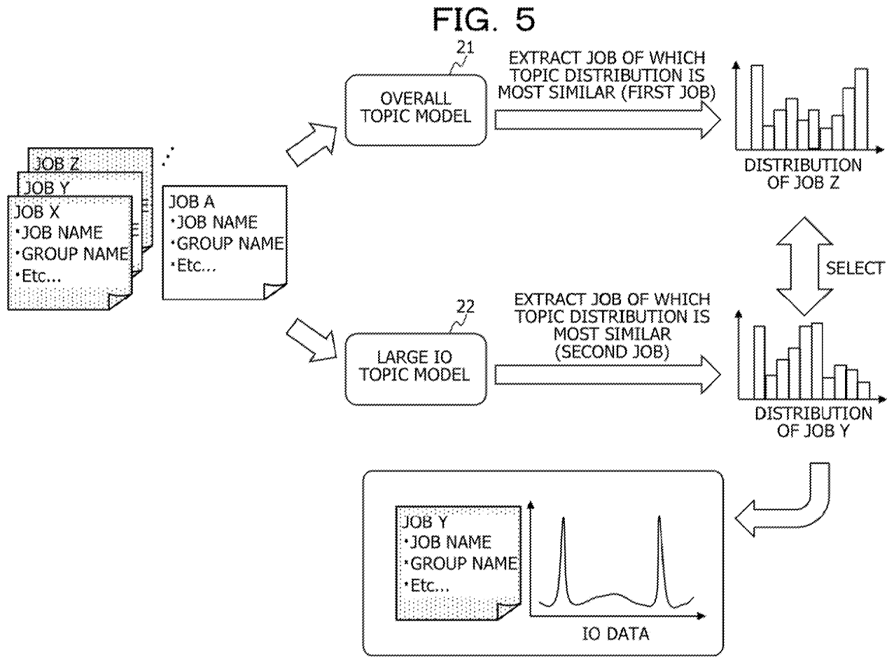

In the present embodiment, as illustrated in FIG. 5, the above problem is solved by using both of a topic model (overall topic model 21) having a wide search target and a topic model (large IO topic model 22) that targets the large IO jobs as a search target. While the large IO topic model 22 achieves high accuracy for the large IO job, it is not possible for the large IO topic model 22 to predict any job other than the large IO job. Therefore, by using the two topic models together, while prediction accuracy of the large IO job is improved, and prediction accuracy of the jobs other than the large IO job is guaranteed.

Hereinafter, the job prediction system 10 will be described in detail.

As illustrated in FIG. 1, the job prediction system 10 functionally includes a training unit 11, the prediction unit 12, and an update unit 16.

The training unit 11 trains the overall topic model 21 using the job information of each of the plurality of past jobs of which the IO data is known as first training data. Furthermore, the training unit 11 trains the large IO topic model 22 using the job information of the large IO job, of the jobs of which the job information is used to train the overall topic model 21, as second training data.

Specifically, the training unit 11 counts an appearance frequency of a word that is a content word that appears each piece of the first training data, groups words that appear in the job information of the same job at a high probability, and assumes each group as each topic. For each of the plurality of topics, the training unit 11 generates the overall topic model 21 by adding a weight according to an appearance rate to each of a predetermined number of words having a high appearance rate for that topic.

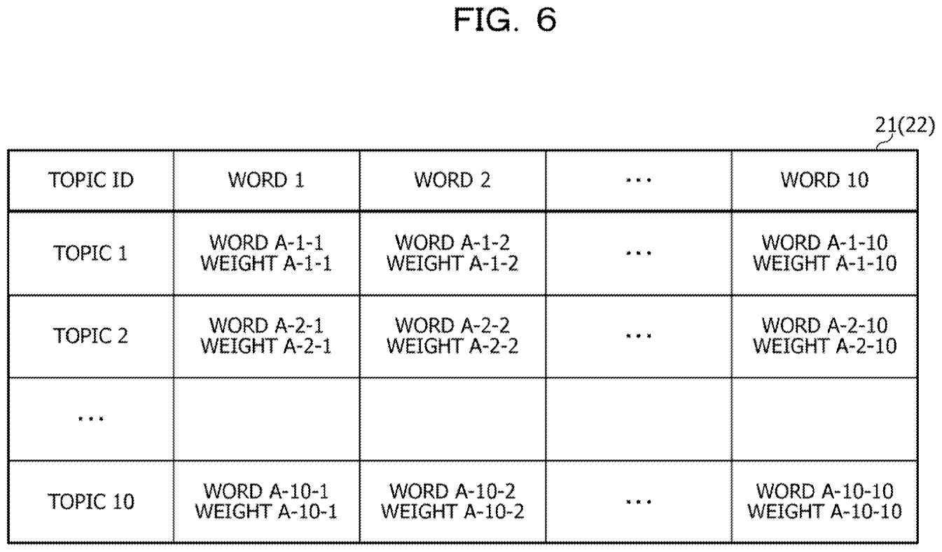

In FIG. 6, an example of the overall topic model 21 is illustrated. In FIG. 6, an example is illustrated in which each of 10 topics includes 10 words. Furthermore, a topic ID that is topic identification information is assigned to each topic. Furthermore, in FIG. 6, “word A-k-n” indicates an n-th word in a k-th topic in the overall topic model 21, and “weight A-k-n” indicates a weight applied to the “word A-k-n”. “A” indicates a word and a weight related to the overall topic model 21 and is a reference used to distinguish the word and the weight from a word and a weight related to the large IO topic model 22 to be described later. Note that the word and the weight related to the large IO topic model 22 are expressed using “B” as “word B-k-n”.

Furthermore, as the second training data, the training unit 11 calculates an average value of an IO amount at each measurement point from start of a job to end (hereinafter, referred to as “average IO value”) for each job from the IO data of each job indicated by the job information that is the first training data. Then, the training unit 11 determines a job of which the average IO value is equal to or more than a predetermined threshold as a large IO job and acquires job information of the large IO job as the second training data. The training unit 11 generates the large IO topic model 22 as in the above using the acquired second training data. A data structure of the large IO topic model 22 is similar to a data structure of the overall topic model 21 illustrated in FIG. 6.

Furthermore, the training unit 11 calculates a topic distribution based on the overall topic model 21 for each job using each piece of the job information that is the first training data. Specifically, the training unit 11 calculates the topic distribution on the basis of the number of appearances of each word in each topic defined by the overall topic model 21 and a weight applied to the word in each piece of the job information. For example, the topic distribution can be calculated using a known method such as a latent dirichlet allocation (LDA).

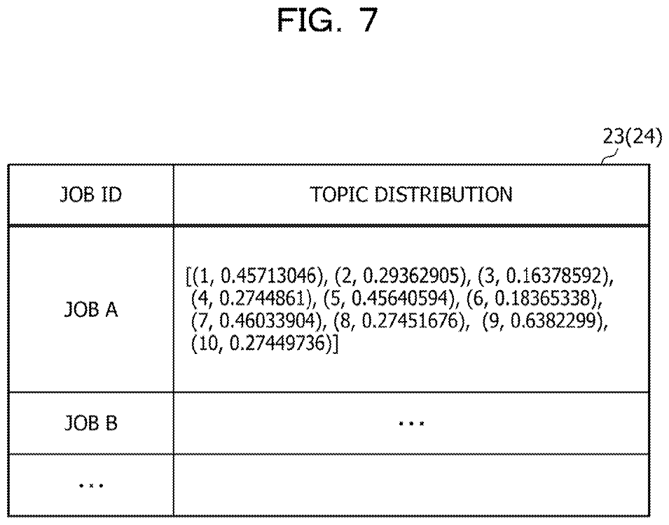

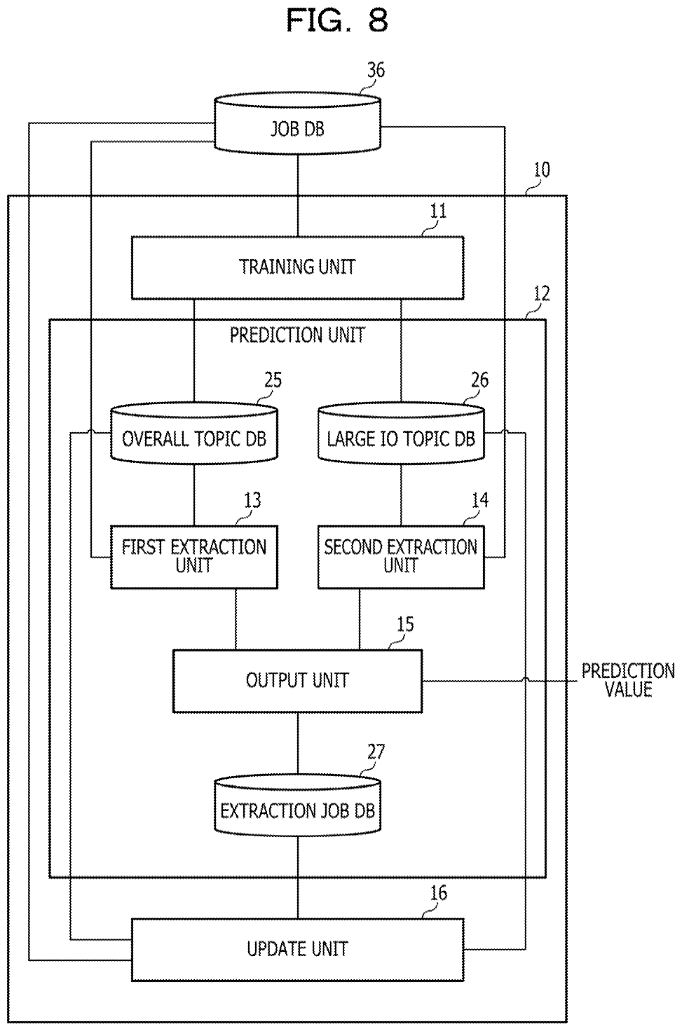

In FIG. 7, an example of a topic distribution 23 based on the overall topic model 21 is illustrated. In the example in FIG. 7, the topic distribution is illustrated using a set for 10 topics (topic ID, probability of topic). The training unit 11 stores the generated overall topic model 21 and the topic distribution 23 based on the overall topic model 21 in an overall topic DB 25 (refer to FIG. 8) stored in a predetermined storage region of the job prediction system 10.

Similarly, the training unit 11 calculates a topic distribution based on the large IO topic model 22 for each job using each piece of the job information that is the first training data. A data structure of a topic distribution 24 based on the large IO topic model 22 is similar to a data structure of the topic distribution 23 based on the overall topic model 21 illustrated in FIG. 7. The training unit 11 stores the generated large IO topic model 22 and the topic distribution 24 based on the large IO topic model 22 in a large IO topic DB 26 (refer to FIG. 8) stored in a predetermined storage region of the job prediction system 10.

As illustrated in FIG. 8, the prediction unit 12 can be expressed as a configuration that further includes a first extraction unit 13, a second extraction unit 14, and an output unit 15. Furthermore, in the predetermined storage region of the job prediction system 10, the overall topic DB 25, the large IO topic DB 26, and an extraction job DB 27 are stored.

The first extraction unit 13 acquires job information of a prediction target job from the job information table 362 of the job DB 36 and calculates a topic distribution based on the overall topic model 21 for the prediction target job. Furthermore, the first extraction unit 13 calculates a COS similarity between each topic distribution based on the overall topic model 21 for each of the past jobs and the topic distribution of the prediction target job stored in the overall topic DB 25. Specifically, the COS similarity is a sum of COSs of probabilities of topics of which topic IDs match each other in the topic distribution. The maximum value of the COS similarity is the number of topics in the overall topic model 21 (here, 10). The first extraction unit 13 extracts a past job having a topic distribution having the maximum COS similarity to the topic distribution of the prediction target job as a first job. The first extraction unit 13 transfers a job ID of the extracted first job and the calculated COS similarity to the output unit 15.

The second extraction unit 14 calculates a topic distribution based on the large IO topic model 22 for the prediction target job. Then, similarly to the first extraction unit 13, the second extraction unit 14 calculates a COS similarity between each topic distribution based on the large IO topic model 22 for each past job and the topic distribution of the prediction target job stored in the large IO topic DB 26. The second extraction unit 14 extracts a past job having a topic distribution having the maximum COS similarity to the topic distribution of the prediction target job as a second job. The second extraction unit 14 transfers a job ID of the extracted second job and the calculated COS similarity to the output unit 15.

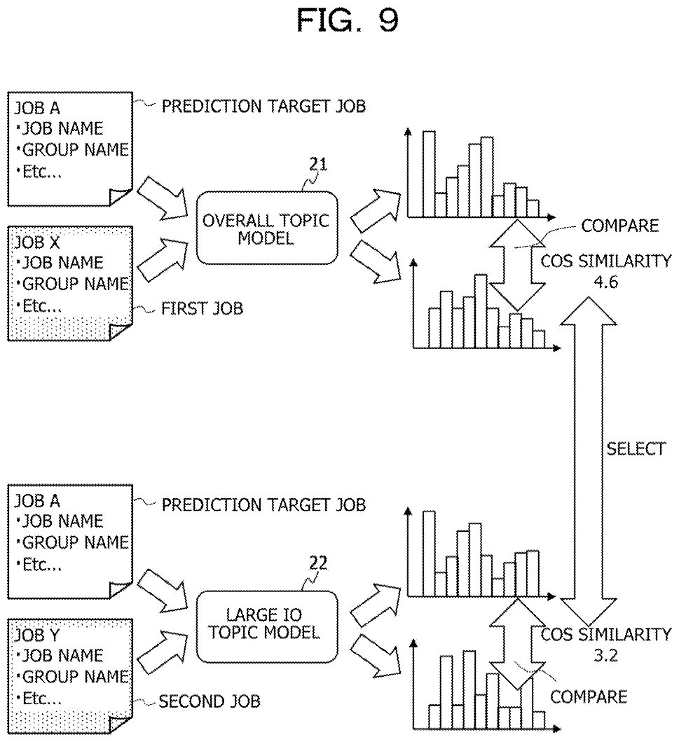

As illustrated in FIG. 9, the output unit 15 compares the COS similarity regarding the first job transferred from the first extraction unit 13 with the COS similarity regarding the second job transferred from the second extraction unit 14 and selects a job with a higher COS similarity. The output unit 15 acquires IO data corresponding to a job ID of the selected job from the IO data table 364 of the job DB 36. The output unit 15 outputs the acquired IO data to the scheduling unit 32 of the management device 30 as the prediction value of the IO data of the prediction target job.

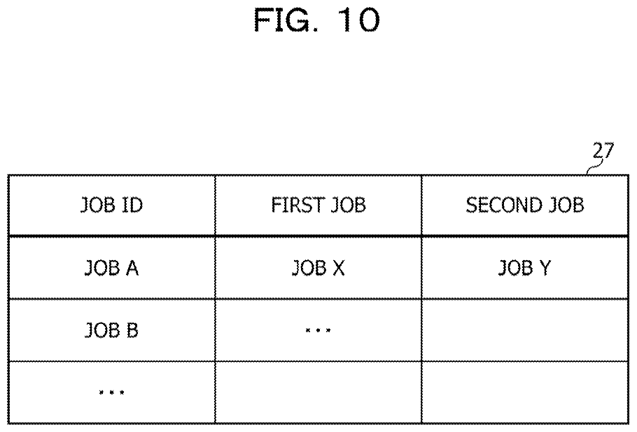

Furthermore, the output unit 15 stores the job ID of the first job transferred from the first extraction unit 13 and the job ID of the second job transferred from the second extraction unit 14 in association with the job ID of the prediction target job, for example, in the extraction job DB 27 as illustrated in FIG. 10.

As illustrated in FIG. 9, the output unit 15 compares the COS similarities between the topic distributions of the prediction target job and each of the first job and the second job. Here, because the topic distributions of the first job and the second jobs are calculated respectively on the basis of different topic models, there is a possibility that proper comparison is not performed and a job that is an optimum job as a job used as the prediction value is not selected.

It is also considered to use a topic model in which the overall topic model 21 and the large IO topic model 22 are integrated. However, for example, in a case where a portion of the topic distribution based on the overall topic model 21 is similar and a portion based on the large IO topic model 22 is not similar, the latter portion disturbs appropriate comparison, and the problem similar to the above occurs.

Therefore, in the present embodiment, the update unit 16 balances the overall topic model 21 and the large IO topic model 22 and updates a weight applied to the word in the topic model so that selection of the one topic model is not disturbed by the another topic model. Hereinafter, the update unit 16 will be described in detail.

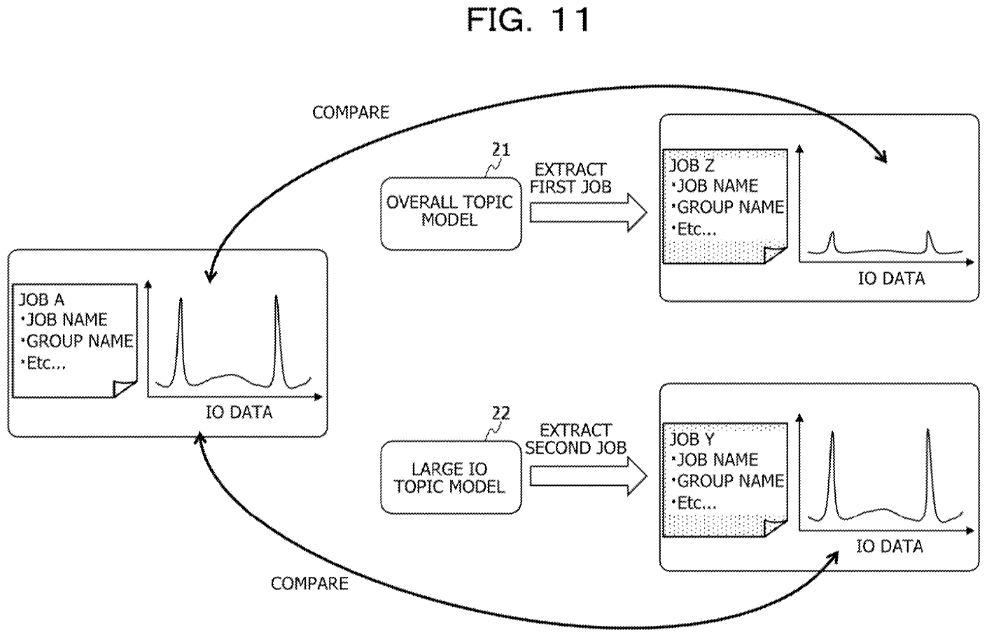

As illustrated in FIG. 11, the update unit 16 calculates an approximation degree between the IO data when the prediction target job is executed and the IO data when each of the first job and the second job is executed. The approximation degree can be calculated through dynamic time warping (DTW) from both pieces of the IO data in consideration of that pieces of IO data regarding jobs of which execution times are different are evaluated. The update unit 16 updates a weight of the word that appears in the job information of the prediction target job in each of the overall topic model 21 and the large IO topic model 22 on the basis of the calculated approximation degree.

Specifically, the update unit 16 reduces the weight of the word that appears in the job information of the prediction target job in each of the overall topic model 21 and the large IO topic model 22 in a case of one of the following two cases.

The first case is a case where the approximation degree between the IO data of the prediction target job and the IO data of the first job exceeds a threshold (value indicating not approximated), the approximation degree between the IO data of the prediction target job and the IO data of the second job is less than the threshold (value indicating approximated), and the prediction target job is a large IO job. The second case is a case where the approximation degree between the IO data of the prediction target job and the IO data of the first job is less than the threshold and the approximation degree between the IO data of the prediction target job and the IO data of the second job exceeds the threshold.

The large IO topic model 22 is trained with the second training data that is a subset of the first training data with which the overall topic model 21 is trained. Therefore, a common word is included in both topic models. Therefore, by updating the weight of the word as described above, both topic models can be balanced.

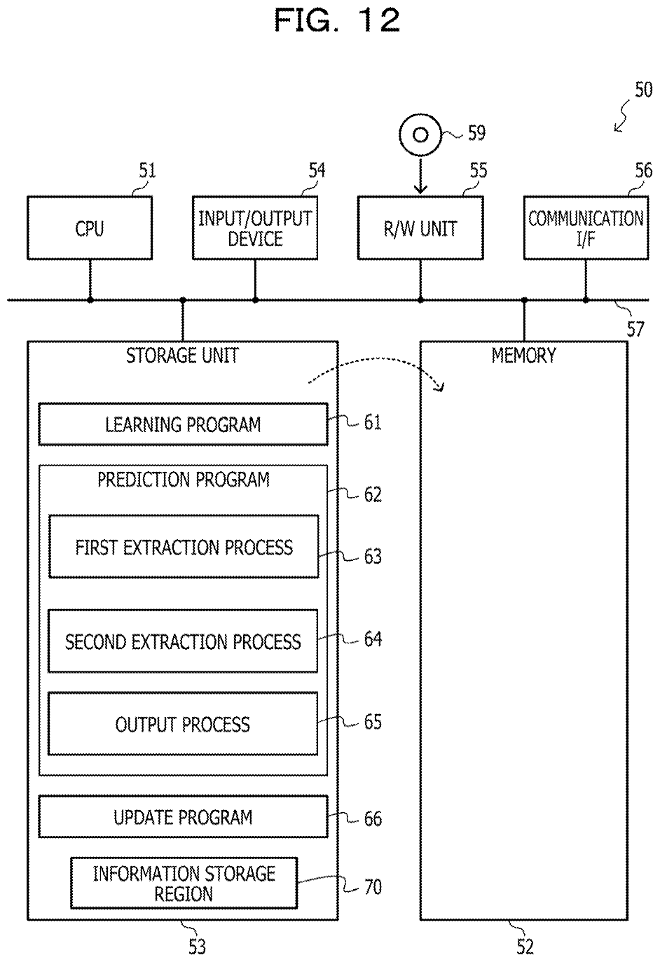

The job prediction system 10 can be implemented by a computer 50 illustrated in FIG. 12, for example. The computer 50 includes a central processing unit (CPU) 51, a memory 52 as a temporary storage region, and a nonvolatile storage unit 53. Furthermore, the computer 50 includes an input/output device 54 such as an input unit or a display unit, and a read/write (R/W) unit 55 that controls reading and writing of data from/to a storage medium 59. Furthermore, the computer 50 includes a communication interface (I/F) 56 to be connected to a network such as the Internet. The CPU 51, the memory 52, the storage unit 53, the input/output device 54, the R/W unit 55, and the communication I/F 56 are connected to each other via a bus 57.

The storage unit 53 may be implemented by a hard disk drive (HDD), a solid state drive (SSD), a flash memory, or the like. The storage unit 53 as a storage medium stores a training program 61, a prediction program 62, and an update program 66 that make the computer 50 function as the job prediction system 10. The prediction program 62 includes a first extraction process 63, a second extraction process 64, and an output process 65. Furthermore, the storage unit 53 includes an information storage region 70 where information included in each of the overall topic DB 25, the large IO topic DB 26, and the extraction job DB 27 is stored. Note that the prediction program 62 and the update program 66 are examples of a job prediction program according to the disclosed technology.

The CPU 51 reads the training program 61 from the storage unit 53 and develops the training program 61 to the memory 52 so as to operate as the training unit 11 illustrated in FIG. 8. Furthermore, the CPU 51 reads the prediction program 62 from the storage unit 53 and develops the prediction program 62 to the memory 52 so as to sequentially execute the processes included in the prediction program 62. The CPU 51 operates as the first extraction unit 13 illustrated in FIG. 8 by executing the first extraction process 63. Furthermore, the CPU 51 operates as the second extraction unit 14 illustrated in FIG. 8 by executing the second extraction process 64. Furthermore, the CPU 51 operates as the output unit 15 illustrated in FIG. 8 by executing the output process 65.

Furthermore, the CPU 51 reads the update program 66 from the storage unit 53 and develops the update program 66 to the memory 52 so as to operate as the update unit 16 illustrated in FIG. 8. Furthermore, the CPU 51 reads the information from the information storage region 70 and develops each of the overall topic DB 25, the large IO topic DB 26, and the extraction job DB 27 to the memory 52. As a result, the computer 50 that has executed the training program 61, the prediction program 62, and the update program 66 functions as the job prediction system 10. Note that the CPU 51 that executes the programs is hardware.

Note that, functions implemented by each program can also be implemented, for example, by a semiconductor integrated circuit, in more detail, an application specific integrated circuit (ASIC) or the like.

Because a hardware configuration of the management device 30 can be implemented by a computer that includes a CPU, a memory, a storage unit, an input/output device, a R/W unit, a communication I/F, or the like similarly to the job prediction system 10, detailed description thereof will be omitted.

Next, an action of the job control system 100 according to the present embodiment will be described.

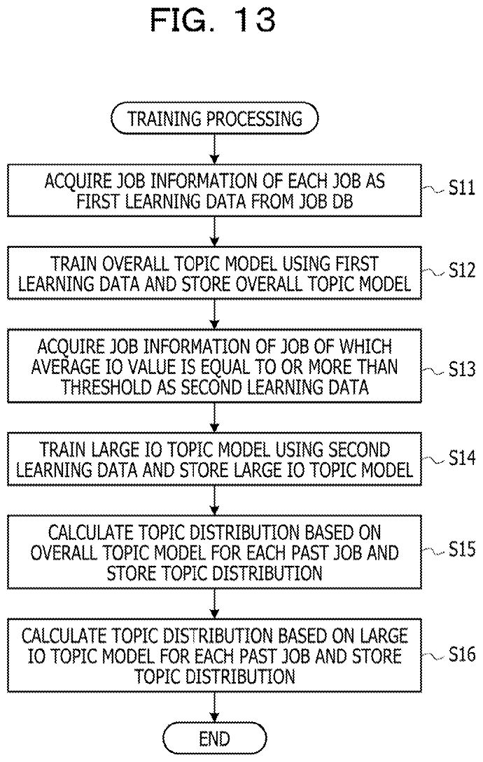

The management device 30 performs control, and the management target system 40 executes a job. As the job is executed, the job information input to the management target system 40 and the IO data measured by the management target system 40 are stored in the job DB 36 of the management device 30. Then, at a predetermined timing (for example, every month), the job prediction system 10 executes training processing illustrated in FIG. 13.

In step S11, the training unit 11 acquires job information of each job stored in the job information table 362 of the job DB 36 as the first training data.

Next, in step S12, the training unit 11 trains the overall topic model 21 using the first training data and stores the overall topic model 21 in the overall topic DB 25.

Next, in step S13, the training unit 11 refers to the IO data table 364 of the job DB 36, determines a job of which an average IO value is equal to or more than a predetermined threshold as a large IO job, and acquires job information of the large IO job as the second training data.

Next, in step S14, the training unit 11 trains the large IO topic model 22 using the second training data and stores the large IO topic model 22 in the large IO topic DB 26.

Next, in step S15, the training unit 11 calculates the topic distribution based on the overall topic model 21 for each job using each piece of the job information that is the first training data and stores the calculated topic distribution in the overall topic DB 25.

Next, in step S16, the training unit 11 calculates the topic distribution based on the large IO topic model 22 for each job using each piece of the job information that is the first training data and stores the calculated topic distribution in the large IO topic DB 26. Then, the training processing ends.

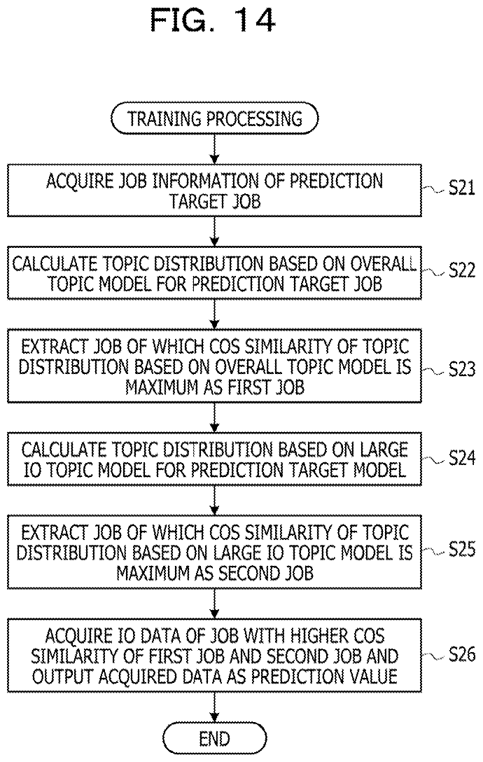

Furthermore, each time when the prediction target job of the IO data is input to the management target system 40, the job prediction system 10 executes prediction processing illustrated in FIG. 14.

In step S21, the first extraction unit 13 and the second extraction unit 14 acquire the job information of the prediction target job from the job information table 362 of the job DB 36.

Next, in step S22, the first extraction unit 13 calculates the topic distribution based on the overall topic model 21 using the job information acquired in step S21 described above, for the prediction target job.

Next, in step S23, the first extraction unit 13 calculates a COS similarity between each topic distribution based on the overall topic model 21 for each job in the past and the topic distribution of the prediction target job calculated in step S22 described above, stored in the overall topic DB 25. Then, the first extraction unit 13 extracts a past job that has a topic distribution with the maximum COS similarity to the topic distribution of the prediction target job as the first job. The first extraction unit 13 transfers a job ID of the extracted first job and the calculated COS similarity to the output unit 15.

Next, in step S24, the second extraction unit 14 calculates the topic distribution based on the large IO topic model 22 using the job information acquired in step S21 described above for the prediction target job.

Next, in step S25, the second extraction unit 14 calculates a COS similarity between each topic distribution based on the large IO topic model 22 for each past job and the topic distribution calculated in step S24 described above, stored in the large IO topic DB 26. Then, the second extraction unit 14 extracts a past job that has a topic distribution with the maximum COS similarity to the topic distribution of the prediction target job as the second job. The second extraction unit 14 transfers a job ID of the extracted second job and the calculated COS similarity to the output unit 15.

Next, in step S26, the output unit 15 stores a job ID of the first job transferred from the first extraction unit 13 and a job ID of the second job transferred from the second extraction unit 14 in association with the job ID of the prediction target job in the extraction job DB 27.

Furthermore, the output unit 15 selects a job ID having a higher COS similarity from the first job and the second job and acquires IO data associated with a job ID of the selected job from the IO data table 364 of the job DB 36. Then, the output unit 15 outputs the acquired IO data as the prediction value of the IO data of the prediction target job to the scheduling unit 32 of the management device 30, and the prediction processing ends.

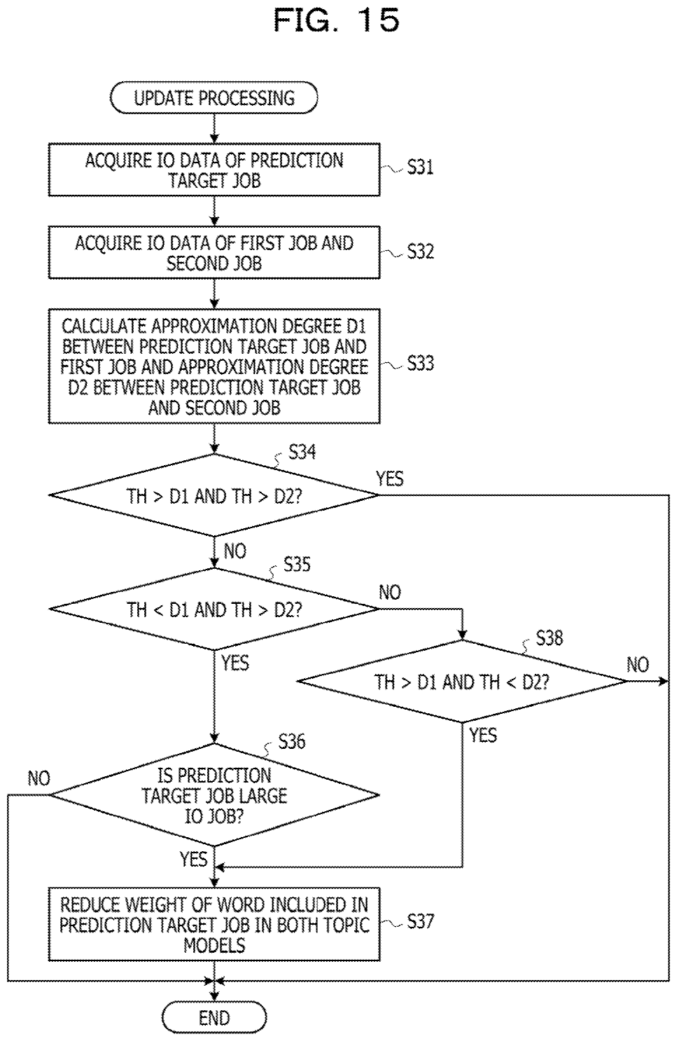

At a timing when the execution of the prediction target job is completed and the IO data is stored in the IO data table 364 of the job DB 36, the job prediction system 10 executes update processing illustrated in FIG. 15.

In step S31, the update unit 16 acquires the IO data of the prediction target job from the IO data table 364 of the job DB 36.

Next, in step S32, the update unit 16 refers to the extraction job DB 27 and specifies the first job and the second job corresponding to the prediction target job. Then, the update unit 16 acquires IO data of each of the first job and the second job from the IO data table 364 of the job DB 36.

Next, in step S33, the update unit 16 calculates an approximation degree D1 between the IO data of the prediction target job and the IO data of the first job, for example, through the DTW. Similarly, the update unit 16 calculates an approximation degree D2 between the IO data of the prediction target job and the IO data of the second job. Note that the approximation degrees D1 and D2 here indicate that the pieces of IO data are more approximated as the value of the approximation degree is smaller.

Next, in step S34, the update unit 16 determines whether or not a threshold TH (for example, 0.1)>D1 and TH>D2, in other words, whether or not prediction of the IO data of the prediction target job is succeeded regardless of which topic model is used. In a case where the prediction is succeeded regardless of which topic model is used, the update processing ends, and in a case where the prediction using at least one of the topic models fails, the processing proceeds to step S35.

In step S35, the update unit 16 determines whether or not TH<D1 and TH>D2, in other words, whether or not the prediction using the large IO topic model 22 is succeeded and the prediction using the overall topic model 21 fails. In a case of affirmative determination, the processing proceeds to step S36, and in a case of negative determination, the processing proceeds to step S38.

In step S36, the update unit 16 determines whether or not the prediction target job is a large IO job by determining whether or not the average IO value of the prediction target job is equal to or more than the predetermined threshold. In a case of the large IO job, the processing proceeds to step S37, and in a case where the prediction target job is not the large IO job, the update processing ends.

In step S37, in each of the overall topic model 21 and the large IO topic model 22, a weight of a word that appears in the job information of the prediction target job is reduced by a predetermined value or a predetermined % (for example, 0.1%). Then, the update processing ends.

On the other hand, in step S38, the update unit 16 determines whether or not TH>D1 and TH<D2, in other words, whether or not the prediction using the overall topic model 21 is succeeded and the prediction using the large IO topic model 22 fails. In a case of affirmative determination, the processing proceeds to step S37, and in a case of negative determination, in other words, in a case where the prediction fails in a case where any topic model is used, the update processing ends.

Note that the prediction processing and the update processing described above are examples of a job prediction method according to the disclosed technology.

As described above, according to the job prediction system according to the present embodiment, the first job having the topic distribution that has the maximum similarity to the topic distribution of the prediction target job is extracted on the basis of the overall topic model trained using the job information of the plurality of jobs. Furthermore, the second job is similarly extracted on the basis of the large IO topic model trained using the job information of the large IO job, which is a part of the plurality of jobs of which information is used to train a first topic model. Then, the IO data of the job having the topic distribution having the higher similarity, of the extracted first job and the second job, is output as the prediction value of the IO data of the prediction target job. This can improve prediction accuracy of a job input/output amount.

Note that, in the embodiment described above, a case has been described where the number of large IO topic models is one. However, a plurality of large IO topic models may be trained using a part of the job information, which is the first training data, which is job information included in each of a plurality of ranges of which IO amounts are different in a stepwise manner. In this case, it is sufficient to extract each second job on the basis of each of the plurality of large IO topic models. Then, it is sufficient to select a job that has a topic distribution with the highest COS similarity to the topic distribution of the prediction target job, from among the first job and the plurality of second jobs. As a result, it is possible to prepare a topic model having a narrower search range for the large IO job, and the prediction accuracy is improved.

Furthermore, in the embodiment described above, a case has been described where the first job and the second job that have the topic distribution most similar to the topic distribution of the prediction target job are extracted and the more similar job is selected. However, the embodiment is not limited to this. For example, one or more first jobs and second jobs having the topic distribution of which the similarity to the topic distribution of the prediction target job is equal to or more than the predetermined value may be extracted. Furthermore, the IO data of the job having the topic distribution of which the COS similarity is up to the predetermined order, of the plurality of extracted first jobs and second jobs, may be acquired, and the prediction value may be output. In a case where a plurality of pieces of IO data is acquired, it is sufficient to generate a prediction value by executing statistical processing such as obtaining an average or maximum value of the IO amounts at each measurement point.

Furthermore, in the embodiment described above, a case has been described where the processing for updating the weight of the topic model is executed each time when the prediction target job is completed. However, the embodiment is not limited to this. For example, the update processing may be executed at a predetermined time such as once a day. In this case, it is sufficient to select a job, on which the update processing is not executed, from among the prediction target jobs stored in the extraction job DB and execute the update processing illustrated in FIG. 15. Note that, as in the embodiment described above, by executing the update processing each time when the prediction target job is completed, it is possible to update the weight of the word in the topic model in real time.

Furthermore, while a mode in which each program is stored (installed) in the storage unit in advance has been described in the embodiment described above, the embodiment is not limited to this. The program according to the disclosed technology may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a job prediction program that causes at least one computer to execute a process, the process comprising:
extracting a first job that has a topic distribution of which a similarity to a topic distribution of a prediction target job is equal to or more than a threshold from among a plurality of past jobs that has an information indicating a data input/output amount at the time of job execution based on a first topic model trained with information regarding a plurality of jobs;
extracting a second job that has a topic distribution of which a similarity to the topic distribution of the prediction target job is equal to or more than a threshold from among the plurality of past jobs based on a second topic model trained with information regarding a job of which the data input/output amount is equal to or more than a predetermined value, the job being a part of the plurality of jobs of which information is used to train the first topic model; and
outputting the data input/output amount of at least one job selected from the first job and the second job that has the topic distribution of which the similarity is up to a predetermined order from a top as a prediction value of the data input/output amount of the prediction target job.

2. The non-transitory computer-readable storage medium according to claim 1, wherein
each of a plurality of second topic models is trained for each of the plurality of ranges of which the data input/output amounts are different in a stepwise manner with an information regarding a job included in each range, and
the process further comprising
extracting each of a plurality of second jobs based on each of the plurality of second topic models.

3. The non-transitory computer-readable storage medium according to claim 1, wherein
the extracting the first job includes extracting a job that has a topic distribution of which a similarity to the topic distribution of the prediction target job is the highest from among the plurality of past jobs based on the first topic model as the first job,
the extracting the second job includes extracting a job that has a topic distribution of which a similarity to the topic distribution of the prediction target job is the highest from among the plurality of past jobs based on the second topic model as the second job, and
the outputting includes outputting the data input/output amount of the job that has the higher similarity of the first job and the second job as the prediction value of the data input/output amount of the prediction target job.

4. The non-transitory computer-readable storage medium according to claim 1, wherein
the first topic model and each of the plurality of second topic models is a model in which a weight according to an appearance rate of each of words that appears in information regarding the job is defined, and
the process further comprising
updating the weight of each of words that appears in information regarding the prediction target job for the first topic model and each of the plurality of second topic models based on an approximation degree between a time-series change in a data input/output amount when the prediction target job is executed and a time-series change in a data input/output amount when the first topic model and each of the plurality of second topic models is executed.

5. The non-transitory computer-readable storage medium according to claim 4, wherein
the updating includes updating the weight as soon as the prediction target job is completed.

6. The non-transitory computer-readable storage medium according to claim 4, wherein the process further comprising
when an approximation degree between the time-series change of the prediction target job and the time-series change of the first job is a value indicating that the time-series change of the prediction target job and the time-series change of the first job do not approximate, an approximation degree between the time-series change of the prediction target job and the time-series change of the second job is a value indicating that the time-series change of the prediction target job and the time-series change of the second job approximate, and the data input/output amount of the prediction target job is equal to or more than a predetermined value, or
when the approximation degree between the time-series change of the prediction target job and the time-series change of the first job is a value indicating that the time-series change of the prediction target job and the time-series change of the first job approximate and the approximation degree between the time-series change of the prediction target job and the time-series change of the second job is a value indicating that the time-series change of the prediction target job and the time-series change of the second job do not approximate,
reducing the weight of each of words that appears in the information regarding the prediction target job in the first topic model and each of second topic models.

7. A job prediction system comprising:
one or more memories; and
one or more processors coupled to the one or more memories and the one or more processors configured to:
extract a first job that has a topic distribution of which a similarity to a topic distribution of a prediction target job is equal to or more than a threshold from among a plurality of past jobs that has an information indicating a data input/output amount at the time of job execution based on a first topic model trained with information regarding a plurality of jobs,
extract a second job that has a topic distribution of which a similarity to the topic distribution of the prediction target job is equal to or more than a threshold from among the plurality of past jobs based on a second topic model trained with information regarding a job of which the data input/output amount is equal to or more than a predetermined value, the job being a part of the plurality of jobs of which information is used to train the first topic model, and
output the data input/output amount of at least one job selected from the first job and the second job that has the topic distribution of which the similarity is up to a predetermined order from a top as a prediction value of the data input/output amount of the prediction target job.

8. The job prediction system according to claim 7, wherein
each of a plurality of second topic models is trained for each of the plurality of ranges of which the data input/output amounts are different in a stepwise manner with an information regarding a job included in each range, and
the one or more processors are further configured to
extract each of a plurality of second jobs based on each of the plurality of second topic models.

9. The job prediction system according to claim 7, wherein the one or more processors are further configured to:
extract a job that has a topic distribution of which a similarity to the topic distribution of the prediction target job is the highest from among the plurality of past jobs based on the first topic model as the first job,
extract a job that has a topic distribution of which a similarity to the topic distribution of the prediction target job is the highest from among the plurality of past jobs based on the second topic model as the second job, and
output the data input/output amount of the job that has the higher similarity of the first job and the second job as the prediction value of the data input/output amount of the prediction target job.

10. The job prediction system according to claim 7, wherein
the first topic model and each of the plurality of second topic models is a model in which a weight according to an appearance rate of each of words that appears in information regarding the job is defined, and
the one or more processors are further configured to
update the weight of each of words that appears in information regarding the prediction target job for the first topic model and each of the plurality of second topic models based on an approximation degree between a time-series change in a data input/output amount when the prediction target job is executed and a time-series change in a data input/output amount when the first topic model and each of the plurality of second topic models is executed.

11. The job prediction system according to claim 10, wherein the one or more processors are further configured to
update the weight as soon as the prediction target job is completed.

12. The job prediction system according to claim 10, wherein the one or more processors are further configured to
when an approximation degree between the time-series change of the prediction target job and the time-series change of the first job is a value indicating that the time-series change of the prediction target job and the time-series change of the first job do not approximate, an approximation degree between the time-series change of the prediction target job and the time-series change of the second job is a value indicating that the time-series change of the prediction target job and the time-series change of the second job approximate, and the data input/output amount of the prediction target job is equal to or more than a predetermined value, or
when the approximation degree between the time-series change of the prediction target job and the time-series change of the first job is a value indicating that the time-series change of the prediction target job and the time-series change of the first job approximate and the approximation degree between the time-series change of the prediction target job and the time-series change of the second job is a value indicating that the time-series change of the prediction target job and the time-series change of the second job do not approximate,
reduce the weight of each of words that appears in the information regarding the prediction target job in the first topic model and each of second topic models.

13. A job prediction method for a computer to execute a process comprising:
extracting a first job that has a topic distribution of which a similarity to a topic distribution of a prediction target job is equal to or more than a threshold from among a plurality of past jobs that has an information indicating a data input/output amount at the time of job execution based on a first topic model trained with information regarding a plurality of jobs;
extracting a second job that has a topic distribution of which a similarity to the topic distribution of the prediction target job is equal to or more than a threshold from among the plurality of past jobs based on a second topic model trained with information regarding a job of which the data input/output amount is equal to or more than a predetermined value, the job being a part of the plurality of jobs of which information is used to train the first topic model; and
outputting the data input/output amount of at least one job selected from the first job and the second job that has the topic distribution of which the similarity is up to a predetermined order from a top as a prediction value of the data input/output amount of the prediction target job.

14. The job prediction method according to claim 13, wherein
each of a plurality of second topic models is trained for each of the plurality of ranges of which the data input/output amounts are different in a stepwise manner with an information regarding a job included in each range, and
the process further comprising
extracting each of a plurality of second jobs based on each of the plurality of second topic models.

15. The job prediction method according to claim 13, wherein
the extracting the first job includes extracting a job that has a topic distribution of which a similarity to the topic distribution of the prediction target job is the highest from among the plurality of past jobs based on the first topic model as the first job,
the extracting the second job includes extracting a job that has a topic distribution of which a similarity to the topic distribution of the prediction target job is the highest from among the plurality of past jobs based on the second topic model as the second job, and
the outputting includes outputting the data input/output amount of the job that has the higher similarity of the first job and the second job as the prediction value of the data input/output amount of the prediction target job.

16. The job prediction method according to claim 13, wherein
the first topic model and each of the plurality of second topic models is a model in which a weight according to an appearance rate of each of words that appears in information regarding the job is defined, and
the process further comprising
updating the weight of each of words that appears in information regarding the prediction target job for the first topic model and each of the plurality of second topic models based on an approximation degree between a time-series change in a data input/output amount when the prediction target job is executed and a time-series change in a data input/output amount when the first topic model and each of the plurality of second topic models is executed.

17. The job prediction method according to claim 16, wherein
the updating includes updating the weight as soon as the prediction target job is completed.

18. The job prediction method according to claim 16, wherein the process further comprising
when an approximation degree between the time-series change of the prediction target job and the time-series change of the first job is a value indicating that the time-series change of the prediction target job and the time-series change of the first job do not approximate, an approximation degree between the time-series change of the prediction target job and the time-series change of the second job is a value indicating that the time-series change of the prediction target job and the time-series change of the second job approximate, and the data input/output amount of the prediction target job is equal to or more than a predetermined value, or
when the approximation degree between the time-series change of the prediction target job and the time-series change of the first job is a value indicating that the time-series change of the prediction target job and the time-series change of the first job approximate and the approximation degree between the time-series change of the prediction target job and the time-series change of the second job is a value indicating that the time-series change of the prediction target job and the time-series change of the second job do not approximate,
reducing the weight of each of words that appears in the information regarding the prediction target job in the first topic model and each of second topic models.
